(19) United States
(12) Patent Application Publication
(10) Pub. No.: US 2020/0232648 A1
(43) Pub. Date: Jul. 23, 2020

(54) Enhanced Pizza Baking and Roasting Apparatus for a Home Oven

(71) Applicant: Gary D. Casper, Clifton Park, NY (US)

(72) Inventor: Gary D. Casper, Clifton Park, NY (US)

(21) Appl. No.: 16/252,658

(22) Filed: Jan. 20, 2019

(51) Int. Cl. F24C 15/16; A47J 37/01

(52) U.S. Cl. CPC F24C 15/16; A47J 37/01

(57) ABSTRACT

A baking and cooking device is disclosed which is used to intensify and concentrate the radiant energy from a home oven broiler element to greatly shorten pre-heating times and baking times, and which produces superior results when used in the preparation of certain pizzas and other foods. The device comprises a low emissivity confining ring which is placed above a heating or cooking surface, which combination may be further set upon a thermally insulating barrier, which are then collectively used for heating and cooking directly under the oven broiler as the primary source of energy. Temperatures and cooking times are easily adjusted through use of the confining wall and heating surface alone, or in combination with the insulating barrier and along with adjustment of the distance below the broiler element in order to achieve a broad range of cooking environments and results. When used within a standard home oven, the device makes it possible to produce true Neapolitan style pizza, many other pizza styles and can also enhance broiling of many other foods. When used for pizza, the ring and heating surface (and if desired the insulating barrier) are placed beneath the broiler for rapid preheating. The confining ring is temporarily displaced to allow a pizza to be placed on top of the heating surface under the broiler, and is again surrounded by the confining ring for baking.

This application claims the benefit of provisional patent application Ser. No. 62/619,797, filed 2018 Jan. 20 by the present inventor.

### BACKGROUND—PRIOR ART

The following is a tabulation of some prior art that presently appear relevant:

U.S. Patents

| Pat. Number | Kind Code | Issue Date | Patentee |
|---|---|---|---|
| 9,903,596 | B1 | 2018 Feb. 27 | Barber |
| 6,101,930 | B1 | 2000 Aug. 15 | Van Over |
| 8,578,927 | B1 | 2016 Nov. 12 | Gustavsen |

U.S. Patent Applications

| Publication Number | Kind Code | Publ. Date | Applicant |
|---|---|---|---|
| 20130295262 | A1 | 2013 Nov. 7 | Giordano |

Nonpatent Literature Documents
Rotio, A., www.kickstarter.com, “Pizza Shelf: Wood-Fired Pizza In Your Oven in 90 Seconds”
(2018 Jan. 22)

### TECHNICAL FIELD

This invention relates to apparatus which are used to enhance the baking and roasting characteristics of home ovens, or other ovens which have inherently limited heating capacities for baking or roasting items, and for cooking processes which benefit from higher temperatures or incident heating radiation. The invention disclosed here relates more specifically to apparatus and components which improve the baking of pizza, however it may be use in the baking or roasting of other foods or food products.

Specifically, the making of high-quality pizza requires high oven temperatures. Home ovens can typically reach a maximum temperature of between 500° F. and 600° F. Such temperatures are not capable of making high-quality pizza, particularly Neapolitan style; which are normally baked in wood, gas or coal fired ovens at temperatures of 800° F. or higher. Heretofore, these types of pizzas have been very difficult or impossible to replicate in the home oven.

### BACKGROUND—PRIOR ART

The use of baking stones or more recently baking steels (simply slabs of firebrick or metal) provide a significant heat mass under the pizza, which aids in energy transfer to a pizza by supplying energy through both direct conduction and through radiation from the stone into the pizza from below. The evolution of home pizza making has gone from an original recommendation for baking on the bottom rack of the oven, as it was believed that placement of a pizza stone or other cooking surface closer to the oven's bottom heating element would result in a hotter surface and thus improve results; to more recently the recommendation for baking stone or steel placement at the upper portion of the oven.

The recognition of the need to add additional top energy into a baking pizza was somewhat revolutionary for home pizza making. This provides additional benefits beyond simply faster baking. The extra boost from the radiant heat coming off of a now more proximal oven ceiling into the top of the pizza resulted faster baking times. Faster baking times can produce better baked goods, in this case pizza, because the dough more fully bakes without the drying effects of longer baking times. Also, additional heating from the oven ceiling helps to balance the baking of the top and bottom of the pizza, which also provides improved results. Another more recent advancement in home pizza baking has been to position a pizza very near the energized oven broiler element and oven ceiling for finishing off the top of a pizza which has already been baked on a stone or steel.

Some of these described methods can be cumbersome and even dangerous, since they often require relocating a pizza with it's extremely hot and heavy stone or steel during the cooking or baking process, and they still cannot produce a Neapolitan style pizza. More recently, small specialty charcoal, wood, and gas fired pizza ovens have become commonly available to the home baker, however these tend to be very expensive and must be used outdoors. Also, the market is replete with products and accessories which attempt to convert outdoor grills to “pizza ovens”. While some of these are somewhat effective, they tend to be very expensive and are also exclusively for outdoor use. Even more recently, a device introduced by Rotio, A. (2018) utilizes a three-sided stainless-steel box to reflect some additional energy from the oven broiler into the baking area, thus creating a hotter environment for baking a pizza. While producing improved results this device is still lacking in that it is permanently lacking in a front reflective wall which leads to uneven cooking of a pizza, and as such requires rotation of the pizza during baking to achieve uniform results. Because of the confining nature of Rotio's device this rotation requires removal of a pizza from the oven to perform. This is difficult, cumbersome and very potentially dangerous. Other significant drawbacks of this device include its high cost of manufacture, heavy weight and large size. It is expensive and is difficult to handle and store. Being very heavy, if dropped it can cause damage to the user or to the floor of the kitchen. Because of its large mass it also retains heat for a long time, which can lead to accidental burns.

What has been so far lacking in the prior art is a device and means to perform high quality Neapolitan style pizza baking in the home oven, simply, safely, and affordably. Concentration has historically been on increasing the temperature of the baking surface and on increasing oven air temperature. Generally unrecognized for home baking was the much more significant effect that direct radiant energy has on the baking process. Air temperature in the oven is not a significant factor, particularly for short baking times as in a pizza. Conduction of heat from the baking surface into the pizza is also of lesser importance, since once the pizza forms a skin of baked dough on the base, conduction is greatly reduced. Radiation of energy from a heated mass proximal to a cooking pizza is also more significant for this type of baking.

It is an object of the present invention to provide a baking device for use in a home oven, which can be used to properly prepare high-quality pizzas and other foods at the very high temperatures required.

It is another object of the present invention to provide a baking device which is compact and light in weight, therefore being easy and inexpensive to ship and easy to store.

It is a further object of the present invention to provide such a device which is simple in design and inexpensive to manufacture.

It is a further object of the present invention to provide such a device which is safe and reliable and consistent with frequent use.

It is yet another object of the present invention to provide such a device which can be used to improve the performance of the ubiquitous and inexpensive baking stones.

It is still another object of the present invention to provide such a device which can be used as a very effective and inexpensive accessory for a baking stone or steel or other heating surface which a user is already in possession of.

It is still yet another object of the present invention to provide such a device which can produce a uniformly cooked pizza without requiring removal and rotation of the pizza during the baking process.

Additionally, it is another object of the present invention to provide such a device which when formed from thin-walled, annealed material can be shaped to conform with a baking pizza or as desired by the user, yet it can be returned to its original shape including tightly rolled for storage.

### Summary

### BRIEF DESCRIPTION OF THE DRAWINGS

FIG. 1 is an exploded view showing the respective positions of an endless confining and reflecting wall portion, heating surface, an oven shelf and a pizza.

FIG. 2 is an exploded view showing the respective positions of an endless confining and reflecting wall portion, heating surface, underlying insulating portion, an oven shelf in a pizza.

FIGS. 3A and 3B are a front and side view cross-section through an oven, showing the relative arrangement of an endless confining and reflecting wall portion, a heating surface, and insulating portion, and a pizza beneath the oven broiler element. Also shown are the paths of radiating, reflected and re-radiated energy from the broiler element to the endless confining and reflecting wall portion to the heating surface.

FIG. 4A to 4D show respectively a reflective and confining wall portion in strip form, whereas its ends may be joined to form an endless reflective and confining wall portion using any clip fastening means, a smaller enrolled form, and a tightly rolled form for easy shipping and storage.

FIGS. 5A and 5B respectively show open heart and open rectangle shapes which may be formed when the reflective and confining wall portion is made of a flexible and annealed material.

FIGS. 6A and 6B show front top and side views of another embodiment comprising multiple movable wall segments attached to a base stand portion, an insulating portion and a heating surface.

FIG. 7 shows a graph of experimental data demonstrating the significantly increased temperatures which can be obtained using various configurations with the apparatus disclosed herein.

### DETAILED DESCRIPTION OF THE DRAWINGS

The invention disclosed herein is, of course, susceptible of embodiment in many different forms. Shown in the drawings and described hereinbelow in detail are preferred embodiments of the invention. It is to be understood, however, that the present disclosure is an exemplification of the principles of the invention and does not limit the invention to the illustrated embodiments From the foregoing, it will be observed that numerous modifications and variations can be effected without departing from the true spirit and scope of the novel concepts of the present invention. It will be appreciated that the present disclosure is intended as an exemplification of the invention, and is not intended to limit the invention to the specific embodiments illustrated. The disclosure is intended to cover by the appended claims all such modifications as fall within the scope of the claims.

The present invention is an enhanced pizza baking and roasting apparatus for a home oven which can be used to provide greatly elevated energy and temperatures to the cooking environment, which may be particularly helpful for making pizzas. The apparatus includes an endless confining and reflecting wall portion, and insulating portion which together can redirect and intensify the pre-heating of a heating surface and accelerate the cooking process greatly.

When used for making a pizza, the endless confining and reflecting wall portion is placed around the perimeter of the heating surface, and optionally for greater effect it may be placed on top of an insulating portion. The above configuration is then placed on the oven shelf directly below and proximal to the broiler element. When the heating surface has reached the desired temperature for baking, the endless confining and reflecting wall portion is temporarily repositioned or removed to provide access to the heating surface. A pizza is then placed on the heating portion and the endless confining and reflecting wall portion or portions are returned to their original position for baking.

The position of the endless confining and reflecting wall portion relative to the pizza being cooked can be easily adjusted. As well, the distance from the oven broiler element can also be adjusted by using a lower oven shelf. These adjustments are made in accordance with the operator's interests and according to what type of pizza is being made.

Referring now to the detailed drawings, there is illustrated a device in accordance with the present invention which demonstrates the preferred embodiment of the present invention, wherein like referenced numerals refer to like elements throughout the drawings.

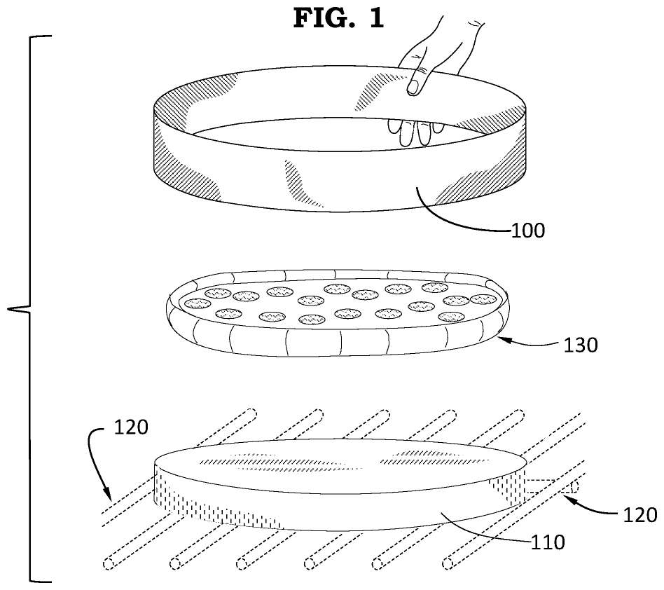

FIG. 1 shows a preferred embodiment of an enhanced pizza baking and roasting apparatus illustrated as a thin-walled, endless, confining, and reflecting wall portion 100 as a closed ring or continuous loop of low emissivity material. The ring rests upon the surface of or just outside the perimeter of a heating surface 110. Said heating surface 110 rests on an oven shelf 120 beneath the broiler element of the home oven for preheating. Also shown is a pizza 130 which is placed onto said heating surface 110 after it is fully heated. Said reflecting wall 100 is then replaced around the perimeter of pizza 130 for baking.

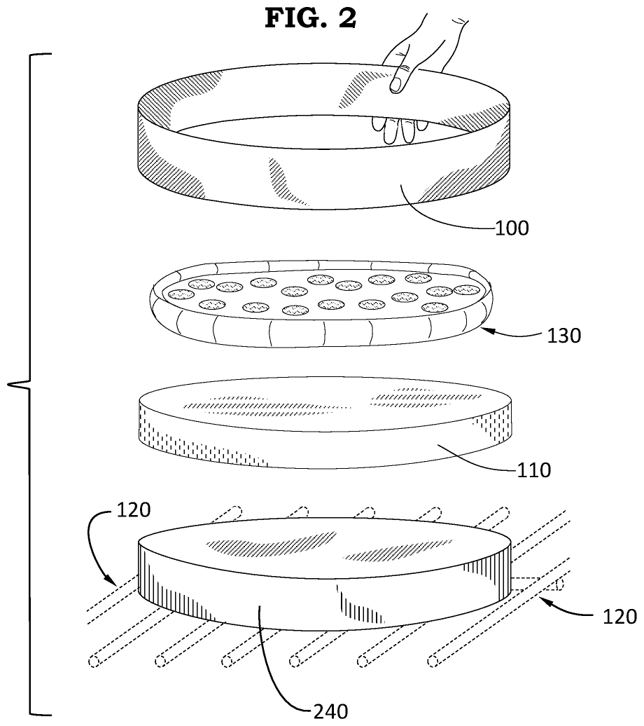

FIG. 2 shows a slightly different embodiment of that shown in FIG. 1, with said endless confining and reflecting wall portion 100 and with the addition of an insulating portion 240 placed directly beneath said heating surface 110 and set directly upon said oven shelf 120. This embodiment results in even higher temperatures being attained in said heating surface 110 due to the reduction of heat loss through the bottom of said heating surface 110.

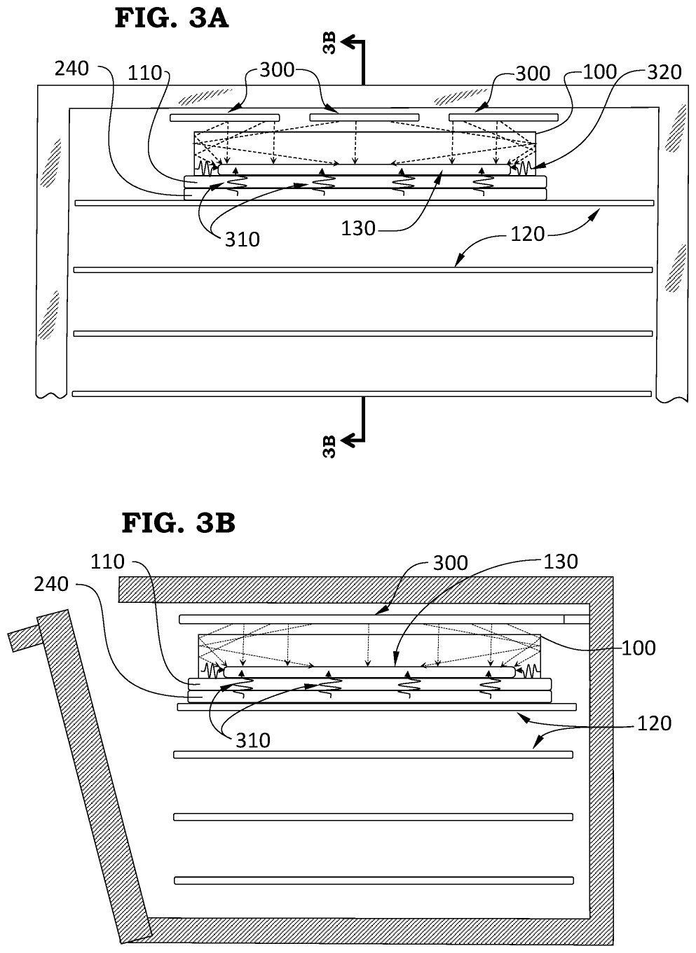

FIGS. 3A and 3B are respectively a front view and side view cross-section through an oven of the embodiment shown in FIG. 2, illustrating the relative arrangement of said endless confining and reflecting wall portion 100 on top of said heating surface 110, further on top of said insulating portion 240, and set upon said oven shelf 120. Said pizza 130 is shown beneath an oven broiler element 300 on top of said heating surface 110. Also shown are the paths of radiant energy from said oven broiler element 300 as reflected off of said endless confining and reflecting wall portion 100, and also re-radiated energy 320 emitted from said endless confining and reflecting wall portion 100 to said heating surface 110. The heat blocked 310 by said insulation portion 240 is also illustrated.

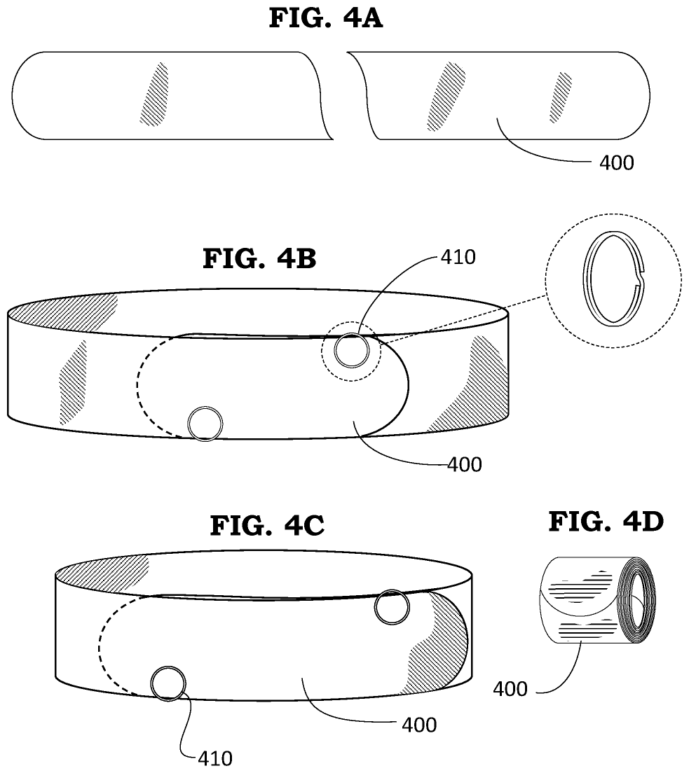

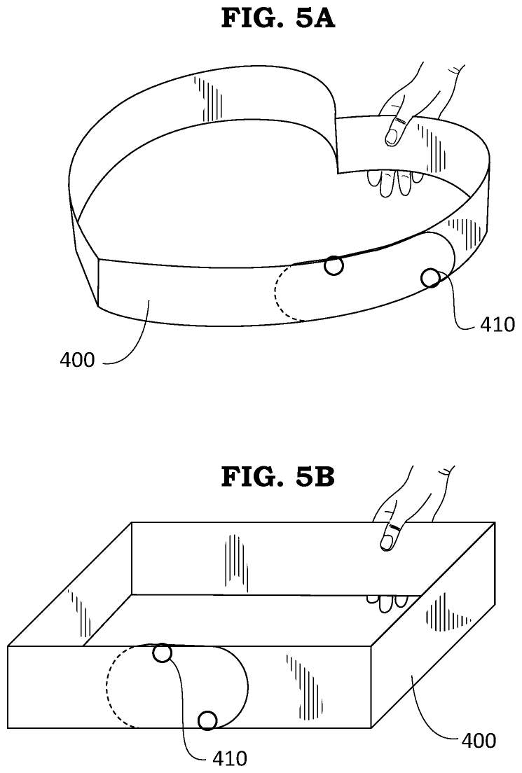

FIGS. 4A-4D and FIGS. 5A and 5B show another alternative embodiment of an endless confining and reflecting wall portion. FIG. 4A shows a flexible and open-ended strip of low emissivity material 400, which as shown in FIG. 4B may be joined together by any fastening means 410, thus resulting in an endless loop. FIG. 4C shows said strip of low emissivity material 400 formed into a smaller diameter endless loop. FIG. 4D illustrates said strip of low emissivity material 400 rolled into a tight coil for easy shipment and storage. Said strip of low emissivity material 400, if constructed from annealed material will remain coiled without fastening and will readily uncoil into a flat strip again for use. FIGS. 5A and 5B illustrate just a few of the infinite shapes possible, which may be formed from said flexible and open-ended strip of low emissivity material 400 connected with said fastening means 410, where constructed from an annealed material.

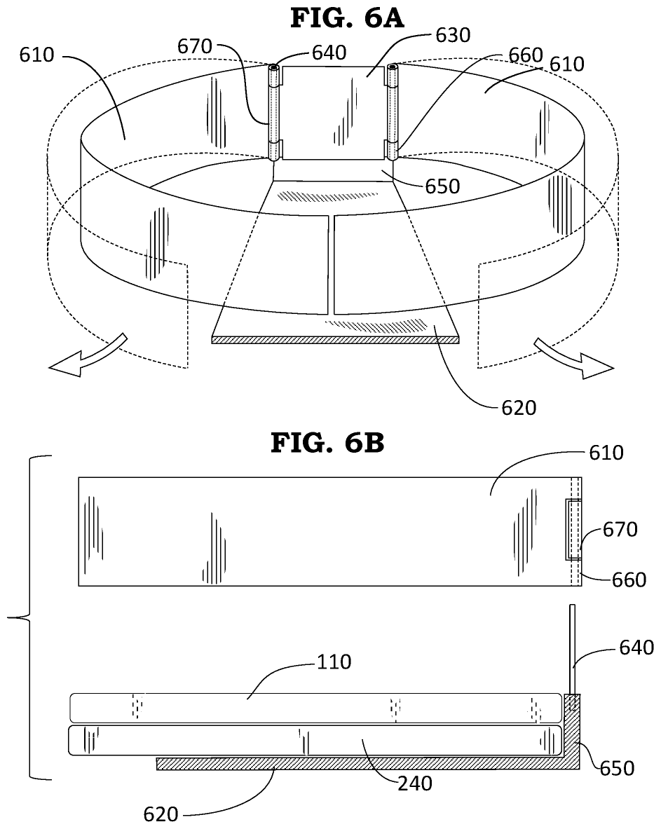

FIGS. 6A and 6B illustrates an additional alternative embodiment where an endless confining and reflecting wall portion is formed from multiple confining and reflecting wall segments 610. In the example shown said confining and reflecting wall segments 610 are joined with a central holder segment 630 via wall segment hinges 660 and central holder segment hinge 670 via a hinge pin 640 which inserts into a vertical ring stand riser portion 650 which in turn is connected with a perpendicular horizontal ring stand base portion 620. In use, said reflecting wall segments 610 form jaws which can be easily spread apart and back together in order to facilitate placement and removal of a pizza (not shown) onto and from said heating surface 110. Said ring stand base portion 620 is held in place by the weight of overlying said insulating portion 240, and heating surface 110.

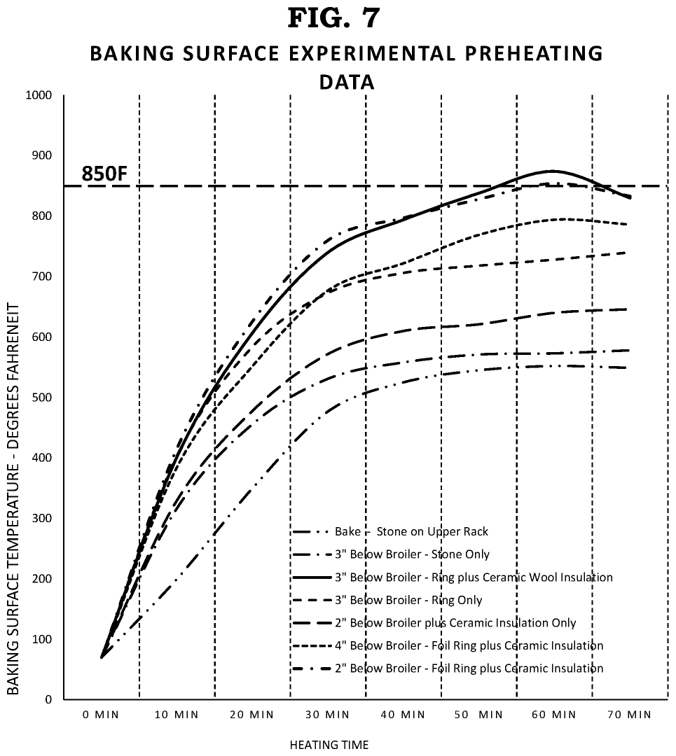

FIG. 7 is a graph of experimental data which illustrate just how significant the additional heating provided by the disclosed enhanced pizza baking and roasting apparatus can be. The lower curve on the chart represents pre-heating a baking stone in a standard oven on the bake cycle. The upper four curves illustrate times and temperatures which were attained using said endless confining and reflecting walls 100, 400 or 610 alone (lower two curves) and further in combination with said insulating portion 240 (upper two curves). As can be seen temperatures in excess of 800° F. can be attained. Further test data (not shown) have demonstrated temperatures in excess of 900° F. are very attainable.

The preferred embodiments of the present invention disclosed herein have been discussed for the purpose of familiarizing the reader with the novel aspects of the invention. Although preferred embodiments of this invention have been shown, many changes, modifications, and substitutions may be made by one having ordinary skill in the art without departing from the scope and spirit of the invention as described in the following claims.

1. A baking and cooking apparatus for preparation of pizza or other food items at elevated energy levels utilizing primarily the broiler element within a home oven, said device comprising:
an endless confining and reflecting wall portion, comprising a low emissivity material of sufficient strength to be self-supporting, whereby said confining and reflecting wall portion being positioned on top of or proximate to a heating surface perimeter such that said endless confining and reflecting wall redirects energy from an oven broiler element into the confined cooking area on top of said heating surface, thereby increasing the energy incident to and retained within said cooking area.

2. A baking and cooking apparatus according to claim 1, wherein said endless confining and reflecting wall comprises an elongated flexible strip of said low emissivity material, which when joined end to end by way of any appropriate connection means, forms said endless confining and reflecting wall.

3. A baking and cooking apparatus according to claim 1, wherein said endless confining and reflecting wall comprises an elongated flexible strip of said low emissivity material, where said low emissivity material is in an annealed state, such that the material when joined end to end by way of any appropriate connection means, forms said endless confining and reflecting wall which is capable of being formed into and retaining any desired perimeter configuration.

4. A baking and cooking apparatus according to claim 1, wherein said endless confining and reflecting wall comprises multiple wall segments, which when joined end to end by way of any appropriate connection means, form said endless confining and reflecting wall.

5. A baking and cooking apparatus according to claim 4, wherein said endless confining and reflecting wall comprises multiple moveably joined wall segments, and wherein at least one juncture of two adjoining wall segments may be temporarily decoupled and said wall segments moved apart laterally to separate them, thereby creating a temporary discontinuity in said endless confining and reflecting wall.

6. A baking and cooking apparatus according to claims 1-5, said device comprising:
an endless confining and reflecting wall portion, comprising a low emissivity material of sufficient strength to be self-supporting, whereby said confining and reflecting wall portion being positioned on top of or proximal to said heating surface perimeter redirects energy from an oven broiler element into the confined cooking area on top of said heating surface, thereby increasing the energy incident to and retained within said heating surface;
and, an insulating portion positioned beneath said heating surface such as to impede the flux of heat out of the bottom of said heating surface, thus increasing the amount of energy stored within said heating surface.

7. A baking and cooking apparatus according to claims 1-5, said device comprising:
an endless confining and reflecting wall portion, comprising a low emissivity material of sufficient strength to be self-supporting, whereby said confining and reflecting wall portion being positioned on top of or proximal to said heating surface perimeter redirects energy from an oven broiler element into the confined cooking area on top of said heating surface, thereby increasing the energy incident to and retained within said cooking area;
an insulating portion positioned beneath said heating surface such as to impede the flux of heat out of the bottom of said heating surface, thus increasing the amount of energy stored within said heating surface;
and, a heating surface portion.
